(19) United States
(12) Patent Application Publication
(10) Pub. No.: US 2012/0177303 A1
(43) Pub. Date: Jul. 12, 2012

(54) Apparatus And Method For Creation Of Digital Art Forms From Other Digital Data

(76) Inventors: Ravi K. Gananathan, Richmond Hill (CA); David P. Roach, Richmond Hill (CA)

(21) Appl. No.: 13/496,618

(22) PCT Filed: Sep. 15, 2010
(86) PCT No.: PCT/CA2010/001455

§ 371 Date: Mar. 16, 2012

Related U.S. Application Data
(60) Provisional application No. 61/243,466, filed on Sep. 17, 2009.

(51) Int. Cl. G06K 9/36

(52) U.S. Cl. 382/276

(57) ABSTRACT

Apparatus and method for creation or transformation of digital art forms in 2D/3D images, photos, video, music, voice, etc. based on messages received on or sent from mobile or PC devices via email, SMS, Tweets and other messaging services, as well as other forms of accessible or streaming data such as voice calls, web page data, user input data such as button pushes, other downloadable or downloaded content including analog media converted to digital data, i.e. bit streams of any kind as input. There are no solutions today that use data from other sources as input to create new digital art forms or transform other existing digital art forms.

### FIELD OF THE INVENTION

This invention relates to apparatus and method for automated or semi-automated creation or transformation of digital art forms comprising 2D/3D images, photos, videos, music, voice or other art forms generated from the input of other digital data.

### BACKGROUND OF THE INVENTION

Analog or digital data is usually represented in a format that is meaningful to the user. For example, text data is represented in standard formats, such as ASCII, EBCDIC or other encoding system that allows for the representation of characters that users can read, video data uses video codecs such as those from the MPEG (Motion Picture Experts Group) to create video streams that users can watch, audio data is represented as AAC, MP3, other digital audio formats for easy translation to sound waves. Therefore, it is commonly understood that a text message, such as an SMS (Short Message Service) or Tweet (short micro-blogging messages of fixed number of characters, eg. 140 characters) will be translate as the message that as intended, video streams, such as H.264 encoded streams, will be appropriately decoded and viewed to show the same captured video, and structured documents and text pages will be represented on the internet browser page as written, usually using HTML (Hyper-Text Markup Language) elements.

These standard approaches to viewing received digital data are well known and very common in everyday life. They are highly automated and very quick, thereby allowing users to enjoy high quality pictures, video and music, even on mobile handheld devices like smartphones. They also enable to send and receive a digital message from the other side of the world instantly, within moments of it being sent.

However, there does not exist an automated and quick method to transform this digital data into formats other than for what the data was originally intended for, e.g. a new art form. While the resultant art form, particularly pictures, may resemble other art forms created by other manual means, the automated or semi-automated process and technique of using data from other sources as input to generate new art forms or transform existing art forms does not exist.

There is, therefore, a need for a method that automatically, or semi-automatically, manipulates digital data or digital data streams into new digital art forms or utilize them to transform existing digital art forms.

### SUMMARY OF THE INVENTION

This invention relates to the creation or transformation of digital art forms comprising 2D/3D images, photos, videos, music, voice or other art forms generated from the input of other digital data, particularly text messages, such as, SMS, email, Tweets, and the like sent from computers or mobile devices, web page content, streaming data such as voice telephone calls or unique user created input from button pushes or other documents such as Microsoft Word or Portable Document Format (pdf) files. The input source can be either digital or analog, but the analog data must first be converted to digital form before the process can begin.

It is an object of the present invention to provide a method and apparatus to automatically, or semi-automatically, take in data, preferably digital data as analog data will need to be converted to the digital domain, and convert the input data into an art form.

It is a further object to provide aforesaid data conversion method to also be able to transform an existing art form to create unique compositions.

The invention, thus, in one aspect provides a method of multi-purpose data transformation which enables a user to transform data into a unique art form resulting in a fun experience as it is possible to experience, either through watching or hearing which hearing is possible when the manipulation of audio data is carried out, and, thus, create the art form and let the user experience it as it evolves and transforms. This is especially entertaining when it is a collaborative effort, such as the data having been received from a friend or family member in the form of an email, SMS or Tweet.

Thus, any form of data received as messages or as other forms or saved in other mediums and is readable by a computer can be skillfully manipulated to provide a digital stream of information that is suitable for creating a completely new digital art form that is also fun to watch, hear and even touch as it evolves.

The method according to the invention can also be used to manipulate or transform existing art forms, e.g. music, photograph or any other digital image or media that can also be fun to watch or hear as it is transforms into something new based on the input stream of data.

For example, data from an MP3 file or an SMS or Tweet message can be used to create a new digital image or transform a photograph into an abstract digital art. With new social network sites, the technique can be used to create collaborative art—i.e. friends and associates can contribute by sending messages to each other to create art forms that can further enhance their fun on that social network.

Accordingly, in One aspect, the invention provides a method of transforming data, comprising
receiving digital or analog data and converting or reformatting it into suitable input data using on automated or semi-automated process;
receiving input image;
performing transformative process on received data input and received input image, in an automatic or semi-automatic manner; and
outputting transformed data input that is a combination of both input data and input image.

By the term “analog data” in this specification and claims is meant data represented by a physical quantity that is considered to be continuously variable and has a magnitude directly proportional to the data or to a suitable function of the data.

By the term “digital data” in this specification and claims is meant data represented by discrete values or conditions represented as quantized values of variables.

By the term “data” in this specification and claims is meant digital data, or analog data that will be converted to the digital data format using known prior art methods, before the invention commences its transformative steps,

By the term “automatic” in this specification and claims is meant a method of performing all steps required for the completion of a task (or sub-task), completely independent of a user input.

By the term “semi automatic” in this specification and claims is meant a method whereby at least one step required for the completion of a task is automatic and one other step requires direct user input or intervention.

There are no solutions today that use data from other sources as input to create new digital art forms or transform other existing digital art forms. While the resultant art form may be made to resemble digital art forms created by other means, e.g. manually drawn by artists, the technique of using data streams from other digital sources as input to generate (or transform) another art form is unique and enables creation or transformation of art forms with or without user manipulation in an automated or semi-automated manner.

Practise of the invention, based on the input parameters for desired algorithm(s), produces a new art form or transforms an existing art form that is very pleasing to look at, hear, or even touch (when upcoming technologies are available). More importantly, it is fun to experience the creation of the art form as it evolves, especially when it is a collaborative effort using short SMS or Tweet messages from friends on the social network.

The data can be from a variety of input sources, such as such as incoming SMS, MMS (Multimedia Messaging Service), emails, text documents, portable document format (pdf) files, Tweets, background voices, ambient noise, analog music, web pages, digital books, digital articles, key strokes, touch screen input, other forms of user interface commands or from existing art forms such as music, photographs, or any other digital image.

In a further embodiment, the invention provides a method that extends to non-art form targeted appliances, such as, data protection in the form of hidden messages with art form or encryption that is unfamiliar for most code breaking technologies.

In preferred embodiments the method provides a means to receive data from a friend or group of friends or family, in the form of Tweets, emails, SMS or MMS messages and transform a photo or another image automatically using the received information into a pleasing art form right in front of the user.

In another preferred embodiment, a user selects a file or section of a file or a web page or section of a web page containing the texts or words he/she likes, or simply inputs the words or text he/she wants using a data input device, and the solution transforms an image or a photo using the selected text, automatically or in a semi-automated fashion allowing the user to adjust some of the parameters, into a pleasing art form, for example, in Photo Kiosks and/or in photo printers or in an imaging/printing software application.

In yet other preferred embodiments, one or multiple voice recording(s), received either through a voice mail service on a phone or other messaging services, is/are converted into the digital domain using well-known methods, and are then automatically transformed into a pleasing art form right in front of the user.

In yet other preferred embodiments comprising semi-automatic steps, this allows users to select certain preferences, such as use or non-use of certain colours, shapes or other transformative parameters, before the automatic transformative process begins thereby ensuring the most pleasing experience and results

In one embodiment, the automated method is included with well-known email or texting software and allows users to create their own unique art forms to represent signatures, moods, messages or just simple art.

In a further aspect, the invention provides apparatus for transforming data, comprising
means for receiving and inputting data;
means for receiving input image;
means for performing transformative process on received data input and received input image, in an automatic or semi-automatic manner; and
means for outputting transformed output data that is a combination of both input data and input image.

The method of the invention is generally performed as follows:

1. Selected parameters are reviewed for selection of type of art form, i.e. audio, video, images or the like, and selection of the process method, i.e. creation or transformation of existing art form is effected.

2. Based on the above set of parameters for the selection of type of artwork and process, one or more algorithms to be employed in the method developed are selected.

3. Memory is allocated for creating a new art form or transforming an existing art form. If using an existing art form, then that art form is loaded into memory for transformation.

4. Input data stream, e.g. Twitter messages, is processed by the algorithm(s) to determine the cause of action to be taken to create a new art form or manipulate the selected art form that is loaded into memory. Note that if the input is an analog media, it is first passed through an appropriate digitizer to create a digital data stream before the data stream is delivered to the algorithm(s).

5. A preview window shows the image being created or transformed in the case of images/video or audio is played in the background for music files as the data is received and the algorithm(s) are working and generating the desired art form(s).

6. When enough data is received, the process stops and the user is allowed to view the art form or play the video or audio file. If the art form is of continuous nature, i.e. fluid transformation of audio or video the user is allowed to intervene to stop and save the work.

7. Final art form is then stored in an appropriate format, e.g. JPG or .TIF for images, .M4V, .MP4 or Flash for video, .MP3 for audio, etc.

8. The user is allowed to send this art form as email attachments or upload it to social network sites.

### BRIEF DESCRIPTION OF THE DRAWINGS

In order that the invention may be better understood, preferred embodiments will now be described by way of examples only wherein

FIG. 1 is a flowchart representing the overall process;

FIG. 2a is a block diagram of the process of manually inputting data and automatically transforming the selected image or photo using the input data;

FIG. 2b is a block diagram of the process of selecting a digital input data source and automatically transforming the selected image or photo or another art form, eg. audio) using the input data;

FIG. 2c is a block diagram of the process of using an analog input as data source and automatically transforming the selected image or photo or another art form, eg. audio using the bitstream generated from the analog input source;

FIG. 3 is a block diagram of the process of selecting an input source and automatically creating an art form using the bitstream generated from the input or a combination of bitstream generated and other input data;

FIG. 4a is a block diagram of the process of manually inputting data and semi-automatically transforming the selected image or photo using the input data;

FIG. 4b is a block diagram of the process of selecting a digital input data source and semi-automatically transforming the selected image or photo or another art form, eg. audio using the input data;

FIG. 4c is a block diagram of the process of using an analog input as data source and semi-automatically transforming the selected image or photo or another art form, eg. audio using the bitstream generated from the analog input source;

FIGS. 5a, 5b and 5c are images of prior art digital art that was manually created representing output images that can be created using the said process by using text or words from a selected input source, eg. a file, an email, web pages, SMS, Tweets, or an input device or converted from analog source or some other format;

FIG. 6 is an image of a prior art 3D digital art that was manually created representing an output image that can be created using the said process by using text or words from a selected input source, eg. a file, an email, web pages, SMS, Tweets, or an input device or converted from analog source or some other format;

FIGS. 7a and 7b are images of prior art digital art that was manually created representing output images that can be created using the said process by overlaying text onto photographs;

FIG. 8 is an image of a prior art abstract digital art that was manually created representing an output image that can be created using the said process by using text or words from a selected input source, eg. a file, an email, web pages, SMS, Tweets, or an input device or converted from analog source or some other format;

FIGS. 9a and 9b are images of a prior art abstract digital art that was manually created representing output images that can be created using the said process by using several Tweet or SMS or email messages or other forms of input data streams;

FIG. 10 is a regular digital photograph taken with a digital camera; and

FIGS. 10a, 10b and 10c are manually created transformation of FIG. 10 representing output images that can be created using the said process.

### DETAILED DESCRIPTION OF PREFERRED EMBODIMENTS

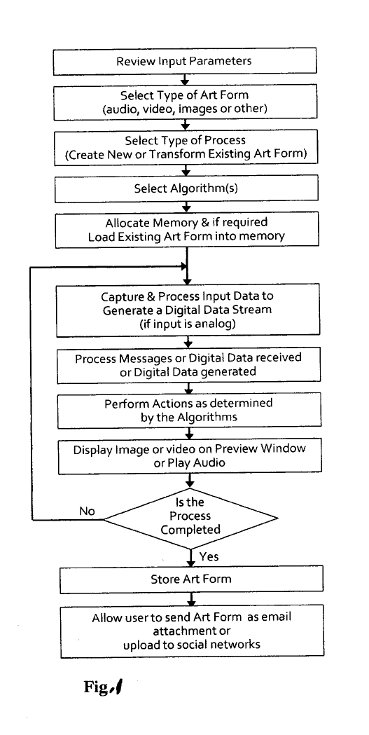

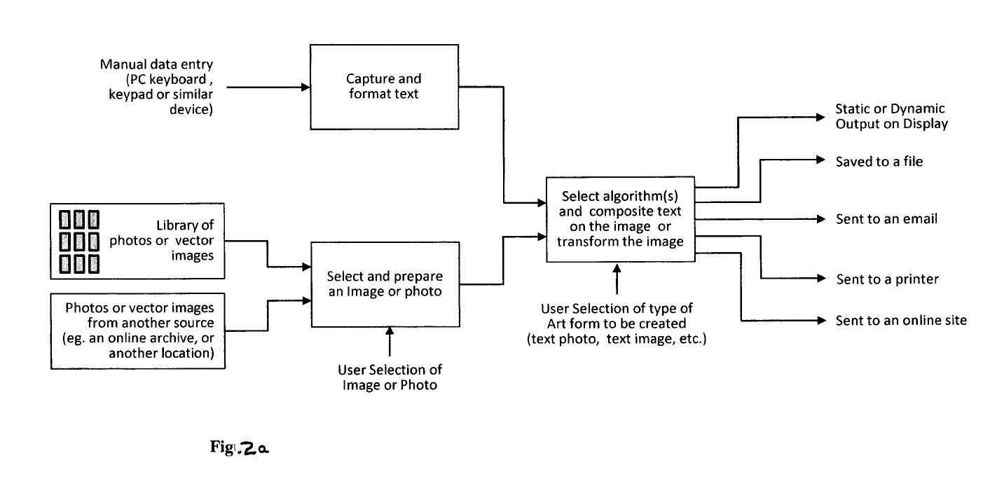

FIG. 1 is a flowchart representing the overall process that are used by all embodiments.

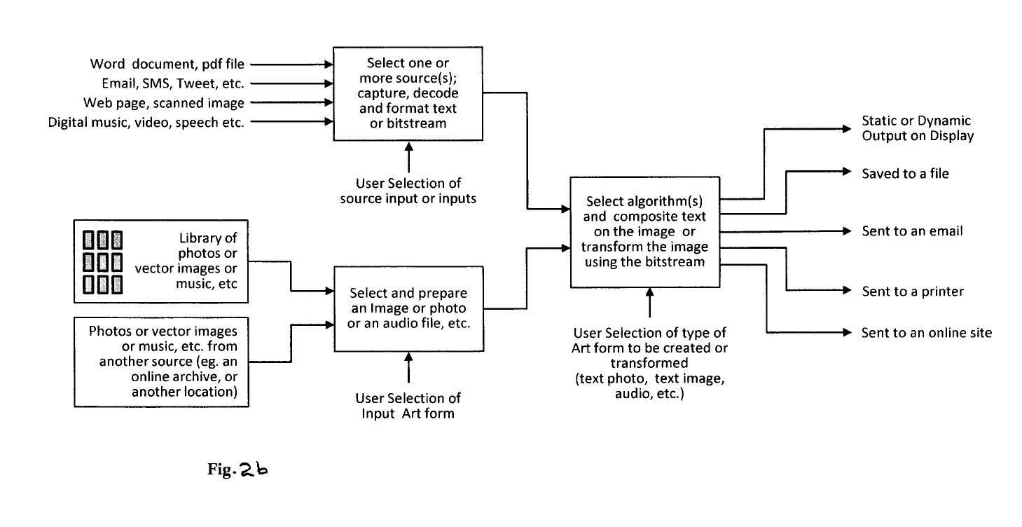

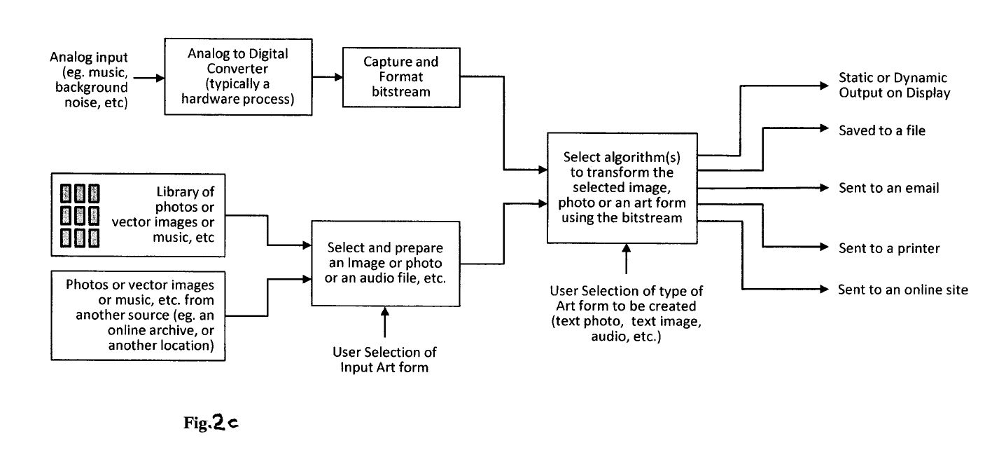

FIG. 2a through FIG. 4c represent the architectures of the embodiments according to the invention supporting various scenarios—specifically:

FIG. 2a is a block diagram of the process employed by an apparatus that receives text entries manually from a keypad or a similar device and automatically transforms the selected art form—an image or photo—using the inputted data.

FIG. 2b is a block diagram of the process employed by an apparatus that receives input data from one or many sources, eg. word document, pdf file, email, sms, tweets, web pages or digital music, video, speech, and the like, and automatically transforms the selected art form—an image or photo or another art form—using the inputted data.

FIG. 2c is a block diagram of the process employed by an apparatus that receives input data from an analog input, digitizes it to create a bit stream and uses this digital stream to automatically transforms a selected art form—an image or photo or another art form.

Note that in preferred embodiments illustrated by FIGS. 2a, 2b and 2c, one or more sources of input, such as keyboard entry, word document, SMS, email, Tweets or Facebook, digital or analog music, etc., can be selected automatically by the apparatus or manually by the user as input to the compositor. Similarly, one or more images or art forms are also selected manually by user or automatically by the apparatus as input to the compositor. The compositor then transforms the selected art form or art forms, using the input data, by one or more algorithms to generate the desired output art form. The output is formatted and displayed for viewing or played back continuously if it is of continuous nature (eg. when using digital or analog music or video streams as input source). The output can be directly sent to a receiving device such display, or to a printer for printing, saved to a file, or sent to an email or other website. The receiving device can be a part of a mobile phone, desktop computer, mobile computer, tablet PC, netbook, new tablet device, such as Apple's iPad, mobile internet devices such as Apple's iPod family of products, home or commercial printing devices, such as printing kiosks at retailer stores or home printer.

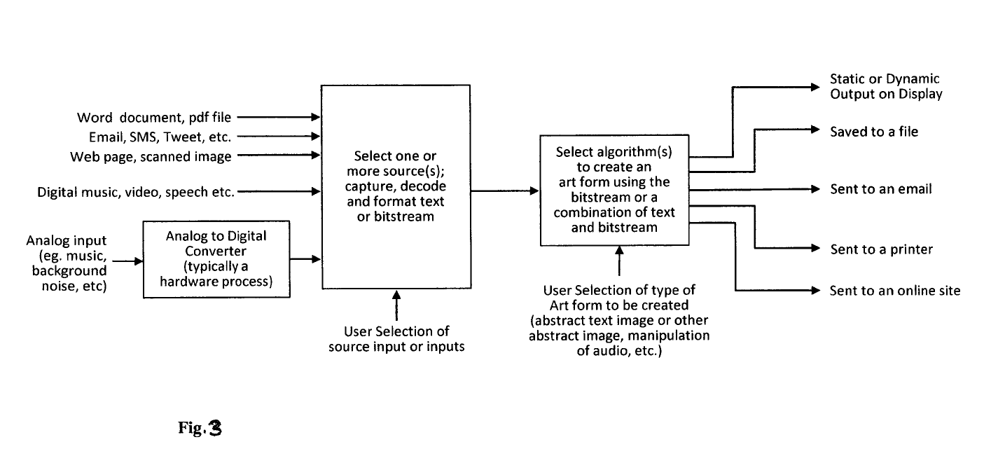

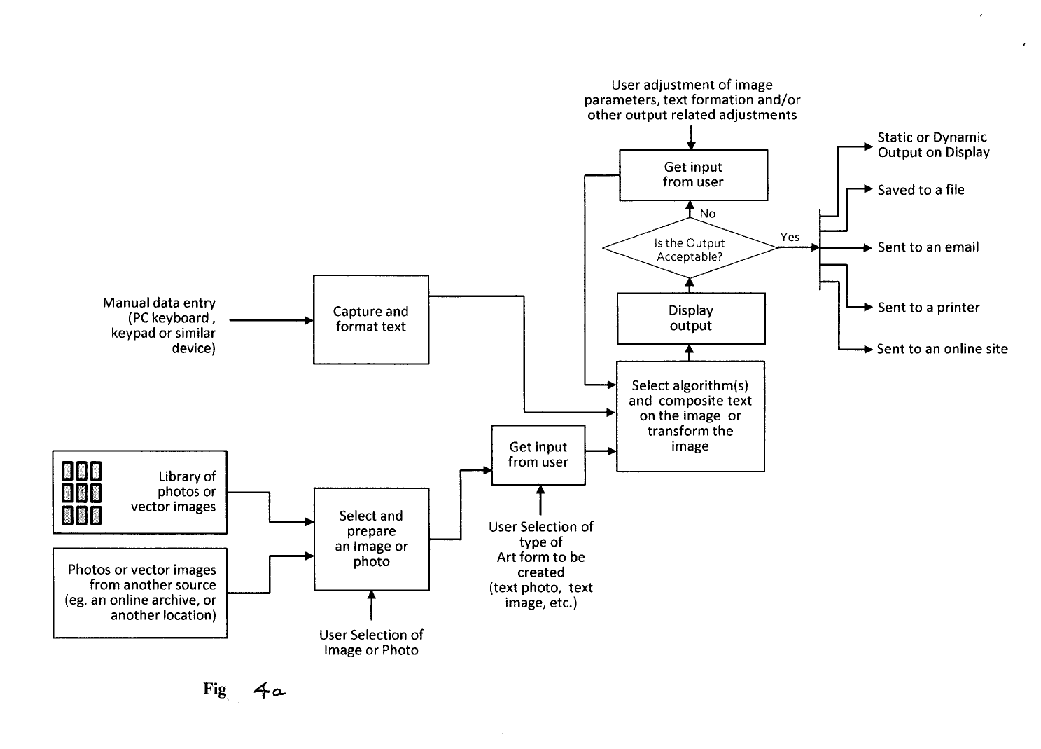

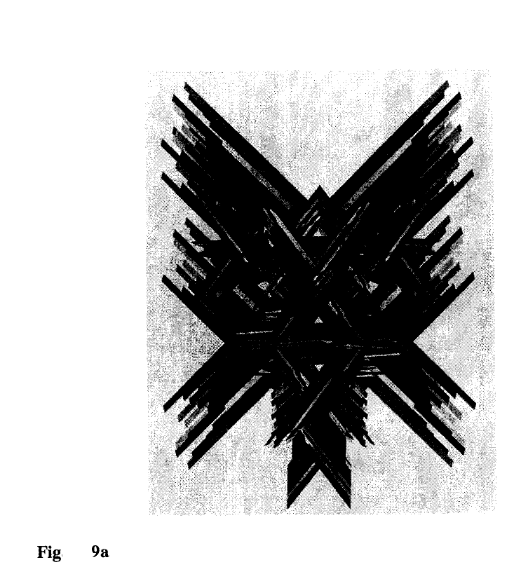

FIG. 3 is a block diagram of the process employed by an apparatus that uses one or many of any type of source as input and automatically creates art form(s)—for eg. abstract art forms shown in FIG. 8, or 9a or 9b—using one or may of inputted data and/or generated bitstream(s).

Note that in the preferred embodiment illustrated by FIG. 3, one or more sources of input, such as word document, SMS, email, Tweets or Facebook, digital or analog music, etc., can be selected automatically by the apparatus or manually by the user as input to the compositor and the compositor automatically generates an art form or art forms utilizing one or more algorithms depending on the selected input(s) to generate the desired output art form. The output is formatted and displayed for viewing or played back continuously if it is of continuous nature, eg. when using digital or analog music or video streams as input source. The output can be directly sent to a receiving device such display, or to a printer for printing, saved to a file, or sent to an email or other website. The receiving device can be a part of a mobile phone, desktop computer, mobile computer, tablet PC, netbook, new tablet device, such as Apple's iPad, mobile internet devices such as Apple's iPod family of products, home or commercial printing devices, such as printing kiosks at retailer stores or home printer.

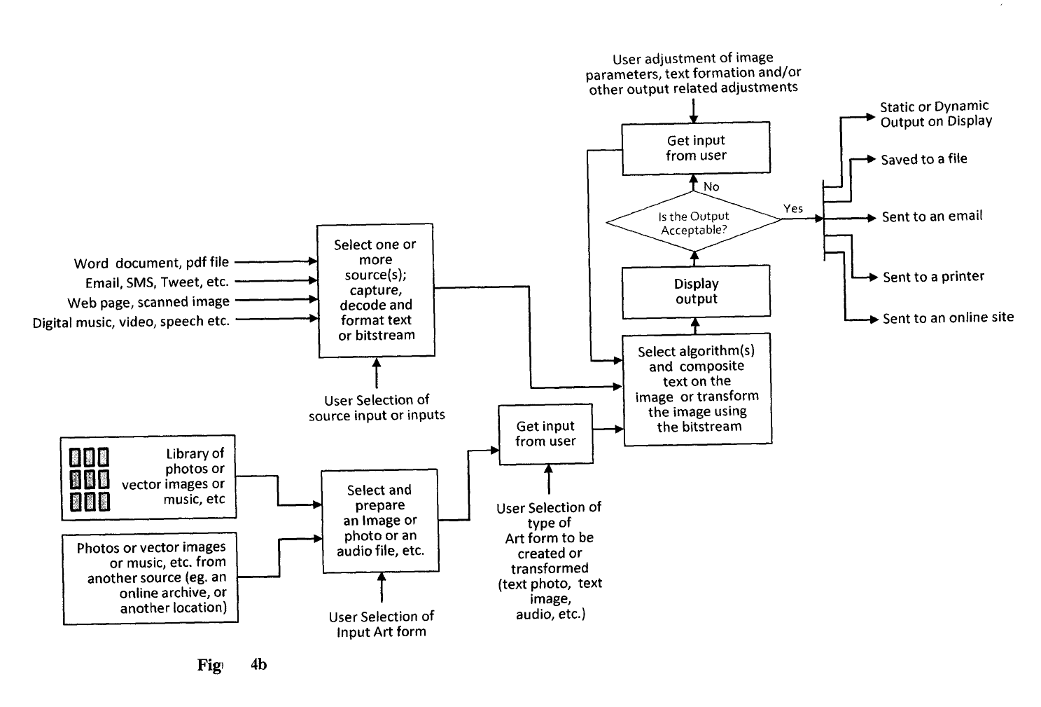

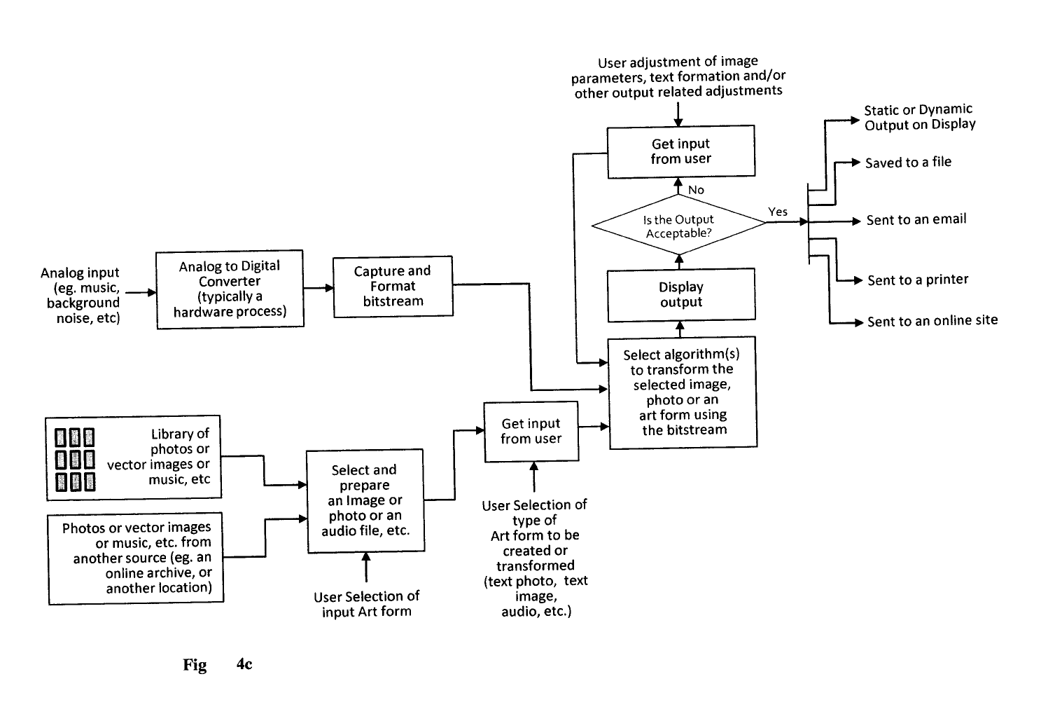

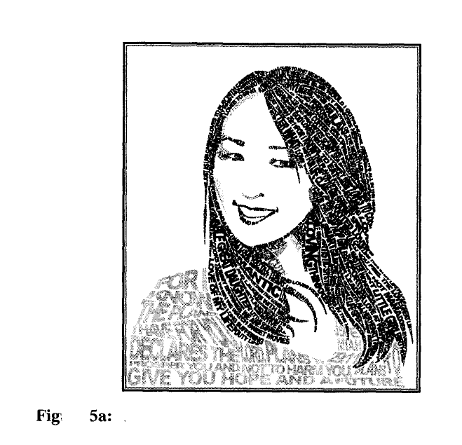

FIG. 4a is a block diagram of the process employed by an apparatus that receives text entries manually from a keypad or a similar device and semi-automatically transforms the selected art form—an image or photo—using the inputted data.

FIG. 4b is a block diagram of the process employed by an apparatus that receives input data from one or many sources, eg. word document, pdf file, email, sms, tweets, web pages or digital music, video, speech, and the like, and semi-automatically transforms the selected art form—an image or photo or another art form—using the inputted data.

FIG. 4c is a block diagram of the process employed by an apparatus that receives input data from an analog input, digitizes it to create a bit stream and uses this digital stream to semi-automatically transforms a selected art form—an image or photo or another art form.

Note that in preferred embodiments illustrated by FIGS. 4a, 4b and 4c, one or more sources of input, such as keyboard entry, word document, SMS, email, Tweets or Facebook, digital or analog music, etc., can be selected automatically by the apparatus or manually by the user as input to the compositor. Similarly, one or more images or art forms are also selected manually by user or automatically by the apparatus as input to the compositor. The compositor then transforms the selected art form or art forms, using the input data, by one or more algorithms to generate the desired output art form. In this semi-automated apparatus, the process provides the user with options to adjust the output results to suit his/her preference. The user can adjust colour, contrast, etc. He/She is also given options to highlight certain words or areas or re-organize certain areas of the image. The user can also request the apparatus to re-engage the algorithm to provide a different output and readjust this output to suit his preference. Once he/she is satisfied, the output is formatted and displayed for final viewing or played back continuously if it is of continuous nature (eg. when using digital or analog music or video streams as input source). The output can be directly sent to a receiving device such display, or to a printer for printing, saved to a file, or sent to an email or other website. The receiving device can be a part of a mobile phone, desktop computer, mobile computer, tablet PC, netbook, new tablet device, such as Apple's iPad, mobile interne devices such as Apple's iPod family of products, home or commercial printing devices, such as printing kiosks at retailer stores or home printer.

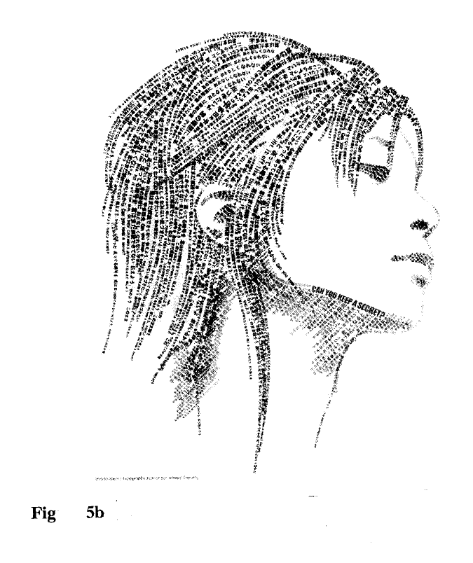

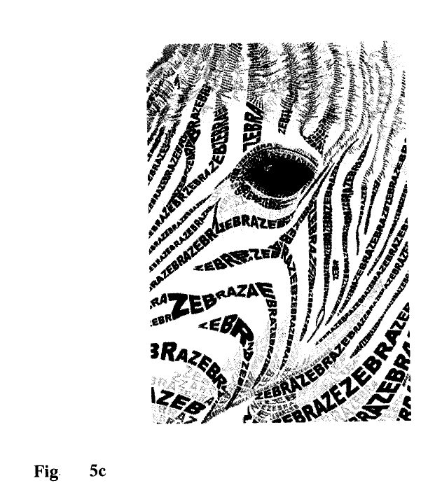

FIG. 5a is a Text Portrait by Jonsibal titled “More than Words”.

Source: http://jonsibal.deviantart.com/art/More-than-Words-77349000.

FIG. 5b is a Text Portrait by Ashed Dreams titled “Utada Hikaru”.

Source: http://fc06.deviantart.com/fs31/f/2008/231/a/8/Utada_Hikaru_Typo_Portrait_by_Ashed_Dreams.jpg.

FIG. 5c is a Text Portrait by FuzzyZebra titled “The Zebra Eye”.

Source: http://fuzzyzebra.deviantart.com/art/the-Zebra-Eye-62720494.

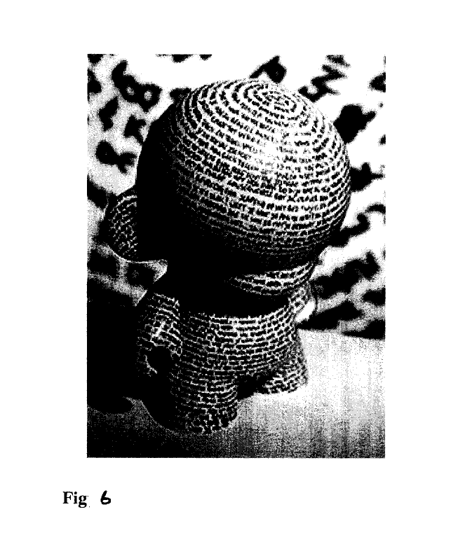

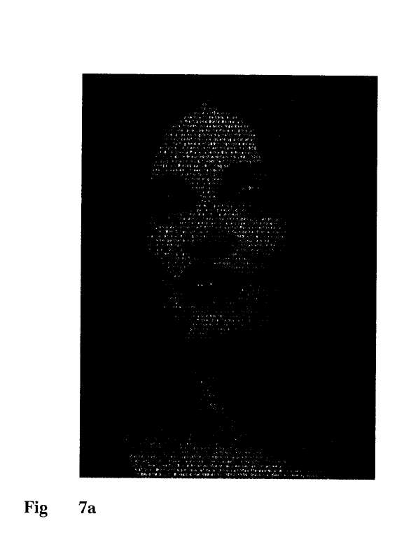

FIG. 6 is a Text wrapped on to a 3D object.

Source: http://www.google.ca/imgres?imgurl=http://img.ffffound.com/
static-data/assets/6/d2fd7de0c33d21c1251e5013bb415c9b5655a063 m.ipg&imgrefurl=http://ffffound.com/
home/tobbz/found/%3Foffset%3D1150%26&usg=K4P-E91nJRICpdfsS1O7VsoaIwg=&h=480&w=320&sz=49&hl=en&sta.

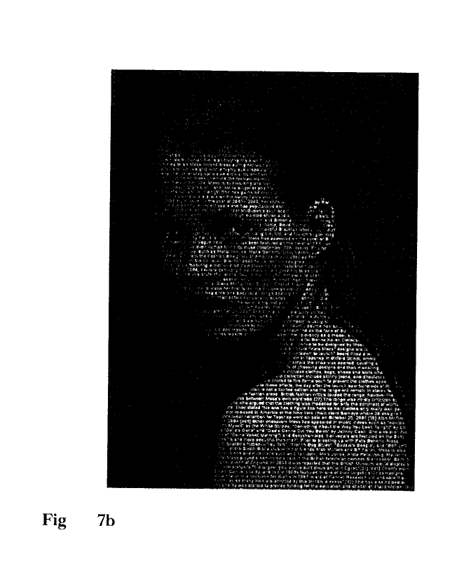

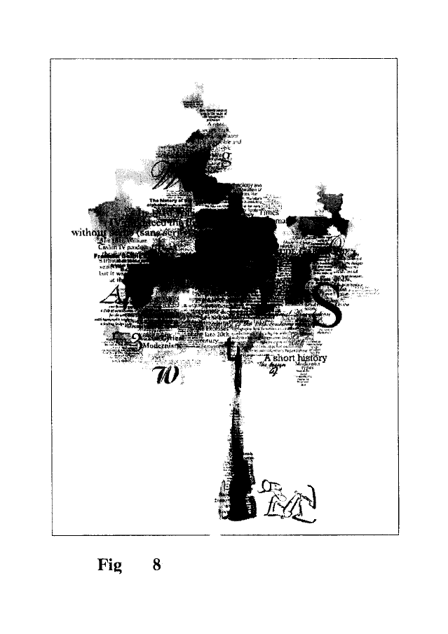

FIG. 7a is a Text Portrait of Madonna by Ralph Ueltzhoeffer by super imposing words on a photograph.

Source: http://arteknyc.wordpress.com/2009/08/05/text-portraits-by-ralph-ueltzhoeffer/

FIG. 7b is a Text Portrait of Kate Moss by Ralph Ueltzhoeffer by super imposing words on a photograph.

Source: http://arteknyc.wordpress.com/2009/08/05/text-portraits-by-ralph-ueltzhoeffer/

FIG. 8 is a Text as an abstract art.

Source: http://www.jackchen.cn/blog/?p=2815

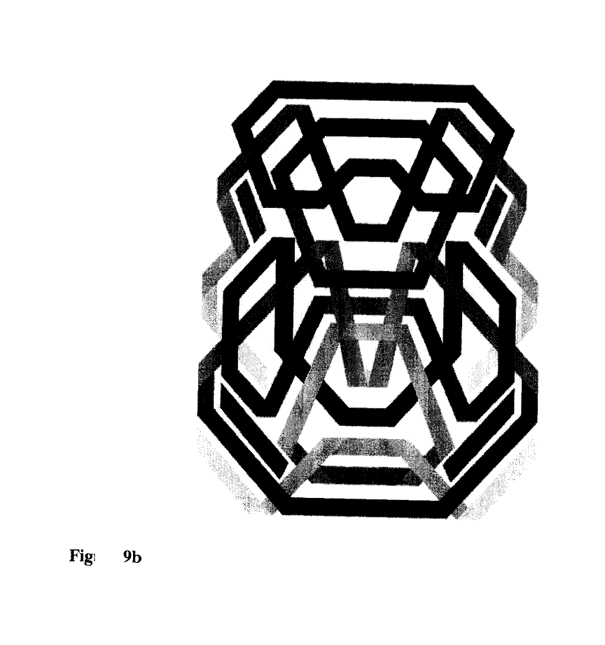

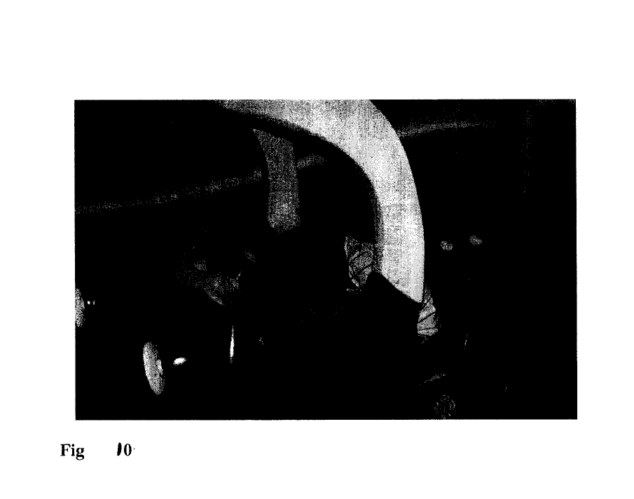

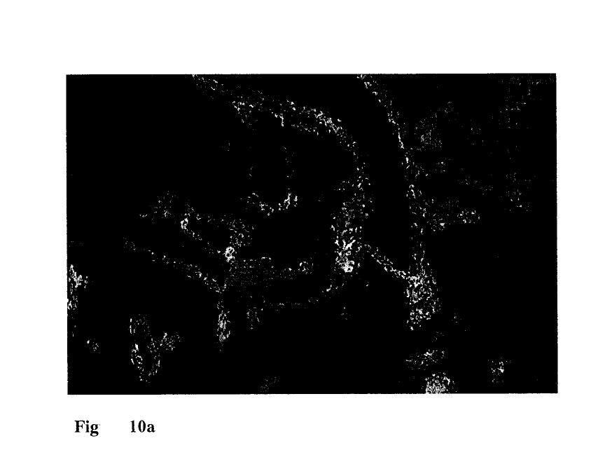

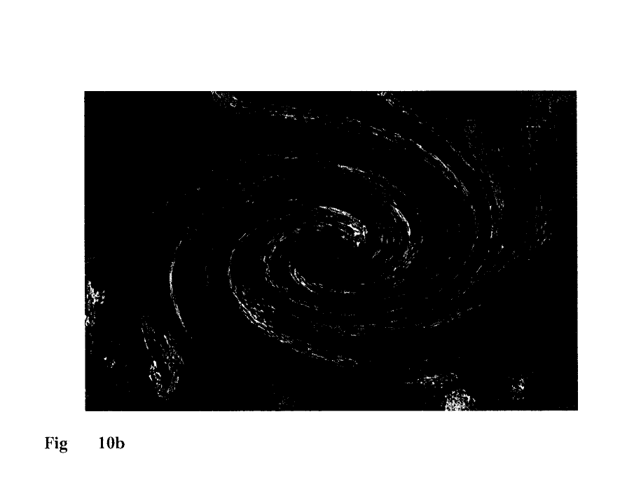

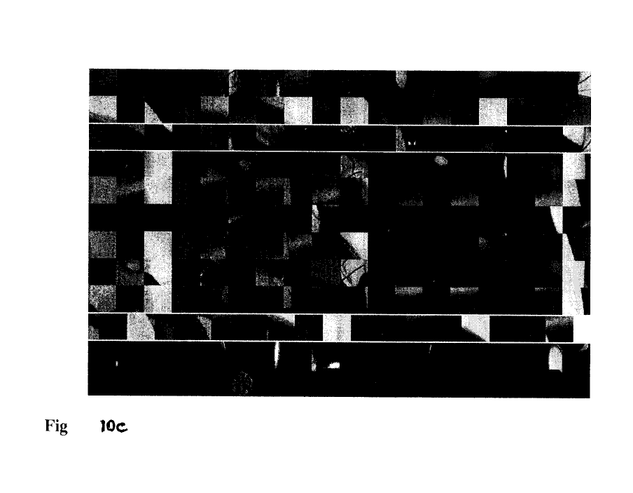

FIG. 9a is a An abstract image formed using several Tweet messages or other forms of input data streams.

Source: http://www.behance.net/Gallery/Abstract-Geometric-Symmetrical Stuff/149774

FIG. 9b is a An abstract image formed using several Tweet messages or other forms of input data streams.

Source: http://www.behance.net/Gallery/Abstract-Geometric-Symmetrical Stuff/149774

Although this disclosure has described and illustrated certain preferred embodiments of the invention, it is to be understood that the invention is not restricted to those particular embodiments. Rather, the invention includes all embodiments which are functional or mechanical equivalence of the specific embodiments and features that have been described and illustrated.

1. A method of transforming data, comprising
receiving and inputting data;
receiving input image;
performing transformative process on received data input and received input image, in an automatic or semi-automatic manner; and
outputting transformed output data that is a combination of both input data and input image or generated automatically based on input data.

2. A method as claimed in claim 1 wherein said input data comprising text selected from the group consisting of emails, documents, song lyrics, song and album titles, speech, SMS messages, MMS messages, Tweets, Facebook messages and websites.

3. A method as claimed in claim 1 wherein said input image is received from a local library or from an external source, such as an online archive.

4. A method as claimed in claim 1 wherein said output data is a static or dynamic image that is shown on a display, saved to a computer file, sent to an email or online site or sent to a printer, either locally or to a retailers' printing kiosk.

5. A method as claimed in claim 1 which is performed automatically.

6. A method as claimed in claim 1 which is performed semi-automatically.

7. A method as claimed in claim 1 wherein said output data is used for security encryption purposes to protect said and input data.

8. An apparatus for transforming data using the method of claim 1 comprising
means for receiving and inputting data;
means for receiving input image;
means for performing transformative process on received data input and received input image, in an automatic or semi-automatic manner; and
outputting transformed output data that is a combination of both input data and input image or generated automatically based on input data.
